(19) United States
(12) Patent Application Publication
(10) Pub. No.: US 2006/0238516 A1
(43) Pub. Date: Oct. 26, 2006

(54) Liquid crystal display with touch panel

(75) Inventor: Lo Wen Kai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/409,935

(22) Filed: Apr. 24, 2006

(30) Foreign Application Priority Data
Apr. 22, 2005 (TW) 94112979

(51) Int. Cl. G09G 5/00

(52) U.S. Cl. 345/173

(57) ABSTRACT

An exemplary liquid crystal display (200) includes a liquid crystal display panel (202), a touch panel (201) adjacent to the liquid crystal display panel, a display driving integrated circuit (206) arranged on the liquid crystal display panel, and a printed circuit board (203). One end of the printed circuit board electrically connects to the touch panel, and another end of the printed circuit board electrically connects to the display driving integrated circuit.

### FIELD OF THE INVENTION

The present invention relates to liquid crystal displays with touch panels.

### BACKGROUND

A liquid crystal display with a touch panel may have the touch panel provided on the front of a display screen. With this configuration, the display screen in effect also functions as an input unit. Various operations can be carried out by a user simply by touching appropriate parts of the touch panel, for example according to a message or a menu or the like displayed on the display screen. These operations are carried out by the user directly touching the touch panel with his/her fingertip.

FIG. 3 is a schematic, side cross-sectional view of a conventional liquid crystal display 100. The liquid crystal display 100 includes a touch panel 101, a band of adhesive film 105, and a liquid crystal display panel 102 arranged in that order from top to bottom. The adhesive film 105 is located between a perimeter portion of the touch panel 101 and a perimeter portion of the liquid crystal display panel 102, and is used for adhering the touch panel 101 and the liquid crystal display panel 102 together. A display driving integrated circuit (IC) 106 is arranged on the liquid crystal display panel 102, to supply voltages for driving the liquid crystal display panel 102. A first printed circuit board 103 and a second printed circuit board 104 are also provided. One end of the first printed circuit board 103 electrically connects with the touch panel 101, and the other end of the first printed circuit board 103 electrically connects with a touch driving integrated circuit (not shown) via connectors (not shown). One end of the second printed circuit board 104 electrically connects with the display driving integrated circuit 106, and the other end of the second printed circuit board 104 electrically connects with a main control circuit (not shown). Both the liquid crystal display panel 102 and the touch driving integrated circuit are controlled by the main control circuit.

However, the first printed circuit board 103 and the second printed circuit board 104 are separately connected with the main control circuit. This configuration needs a large number of connectors and is rather complicated.

What is needed, therefore, is a liquid crystal display that overcomes the above-described deficiencies.

### SUMMARY

A liquid crystal display includes a liquid crystal display panel, a touch panel adjacent to the liquid crystal display panel, a display driving integrated circuit arranged on the liquid crystal display panel, and a printed circuit board. One end of the printed circuit board electrically connects to the touch panel, and another end of the printed circuit board electrically connects to the display driving integrated circuit.

Other advantages and novel features of a preferred embodiment will become more apparent from the following detailed description when taken in conjunction with the accompanying drawings.

### BRIEF DESCRIPTION OF THE DRAWINGS

FIG. 1 is a schematic, side cross-sectional view of a liquid crystal display according to a preferred embodiment of the present invention.

FIG. 2 is a schematic, top plan view of the liquid crystal display of FIG. 1, showing certain hidden parts thereof in phantom.

FIG. 3 is a schematic, side cross-sectional view of a conventional liquid crystal display.

### DETAILED DESCRIPTION OF PREFERRED EMBODIMENT

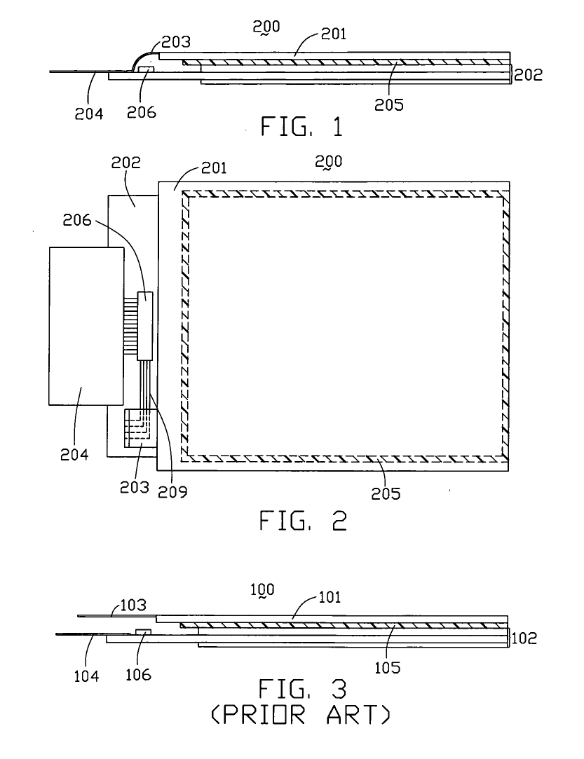

FIG. 1 is a schematic, side cross-sectional view of a liquid crystal display according to a preferred embodiment of the present invention. The liquid crystal display 200 includes a touch panel 201, an adhesive film 205, and a liquid crystal display panel 202 arranged in that order from top to bottom. The adhesive film 205 is located between a perimeter portion of the touch panel 201 and a perimeter portion of the liquid crystal display panel 202, and is used for adhering the touch panel 201 to the liquid crystal display panel 202. A display driving integrated circuit (IC) 206 is arranged on the liquid crystal display panel 202, to supply voltages for the liquid crystal display panel 202. A first printed circuit board 203 and a second printed circuit board 204 are also provided.

Referring to FIG. 2, one end of the first printed circuit board 203 electrically connects with the touch panel 201, and another end of the first printed circuit board 203 electrically connects to the display driving integrated circuit 206 via a plurality of lead wires 209. One end of the second printed circuit board 204 electrically connects with the display driving integrated circuit 206, and another end of the second printed circuit board 204 electrically connects with a main control circuit (not shown). An electrical signal generated by use of the touch panel 201 is transmitted to the display driving integrated circuit 206. The display driving integrated circuit 206 analyzes the electrical signal, and generates a controlling signal that is transmitted to the main control circuit.

In summary, one end of the first printed circuit board 203 is connected to the display driving integrated circuit 206 directly; and the display driving integrated circuit 206 thereby analyzes an electrical signal from the touch panel 201 and generates a controlling signal that is transmitted to the main control circuit. This configuration reduces the number of connectors needed for the first printed circuit board 203, and simplifies the overall structure of the liquid crystal display 200.

It is to be understood, however, that even though numerous characteristics and advantages of an embodiment have been set out in the foregoing description, together with details of the structure and function of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display, comprising:
a liquid crystal display panel;
a touch panel adjacent to the liquid crystal display panel;
a display driving integrated circuit arranged on the liquid crystal display panel; and
a first printed circuit board, one end of the first printed circuit board electrically connecting to the touch panel, and another end of the first printed circuit board electrically connecting to the display driving integrated circuit.

2. The liquid crystal display as claimed in claim 1, further comprising one or more lead wires that electrically interconnect the first printed circuit board and the display driving integrated circuit.

3. The liquid crystal display as claimed in claim 2, wherein the display driving integrated circuit is configured for analyzing an electrical signal generated by the touch panel.

4. The liquid crystal display as claimed in claim 1, further comprising a second printed circuit board, wherein one end of the second printed circuit board electrically connects to the display driving integrated circuit, and another end of the second printed circuit board is configured to electrically connect to a main control circuit of the liquid crystal display.

5. The liquid crystal display as claimed in claim 1, further comprising an adhesive film adhering the touch panel and the liquid crystal display panel together.

6. A liquid crystal display assembly, comprising:
a liquid crystal display panel;
a touch panel adjacent to the liquid crystal display panel;
a display driving integrated circuit arranged on the liquid crystal display panel; and
a first printed circuit board and a second printed circuit board respectively connected to two opposite output ports of said display driving integrated circuit.

7. The assembly as claimed in claim 6, wherein one of said first and second printed circuit boards is connected to the touch panel.

8. The assembly as claimed in claim 7, wherein the other of said first and second printed circuit boards is connected to a main control circuit.

9. A liquid crystal display assembly, comprising:
a liquid crystal display panel;
a touch panel adjacent to the liquid crystal display panel;
a display driving integrated circuit arranged on the liquid crystal display panel; and
one end of a first printed circuit board and one end of a second printed circuit board being located on a same level where said display driving integrated circuit is located at.
